(19) United States
(12) Patent Application Publication
(10) Pub. No.: US 2017/0046019 A1
(43) Pub. Date: Feb. 16, 2017

(54) FILE MANAGEMENT APPARATUS, METHOD FOR SAME AND STORAGE MEDIUM

(71) Applicant: CASIO COMPUTER CO., LTD., Tokyo (JP)

(72) Inventors: Hirokazu HASEGAWA, Tokyo (JP); Naoaki MISAKI, Tokyo (JP); Toshiaki KANAMURA, Tokyo (JP)

(73) Assignee: CASIO COMPUTER CO., LTD., Tokyo (JP)

(21) Appl. No.: 15/187,285

(22) Filed: Jun. 20, 2016

(30) Foreign Application Priority Data
Aug. 10, 2015 (JP) 2015-157913

(51) Int. Cl. G06F 3/0482; G06F 17/30; G06F 7/24; G06F 3/0483; G06F 3/0481; G06F 3/0488

(52) U.S. Cl. CPC G06F 3/0482; G06F 3/04817; G06F 3/04883; G06F 7/24; G06F 3/0483; G06F 17/30091

(57) ABSTRACT

A file management apparatus causes a plurality of book files serving as management targets to be displayed on an editing operation screen in a list form and, each time a file is selected by a user as a processing target, causes a selection order rank set by the user to be individually displayed at a specific position on the editing operation screen corresponding to the file. Then, by combining the plurality of book files selected by the user as processing targets in accordance with the selection order ranks set by the user, the file management apparatus generates a new book file.

### CROSS-REFERENCE TO RELATED APPLICATION

This application is based upon and claims the benefit of priority from the prior Japanese Patent Application No. 2015-157913, filed Aug. 10, 2015, the entire contents of which are incorporated herein by reference.

### BACKGROUND OF THE INVENTION

1. Field of the Invention

The present invention relates to a technique for managing a plurality of files.

2. Description of the Related Art

Conventionally, graphic camera systems have been known in which overlapping pages of a book or the like (for example, book or magazine) are separated and turned one by one by using an automatic page turning apparatus and photographed and converted into electronic data, so that electronic data of a plurality of pages is recorded as a book file.

However, in the above-described case where a book or the like is converted into electronic data and recorded as a file, management of these files becomes cumbersome as the number of recorded files increases.

### SUMMARY OF THE INVENTION

In accordance with one aspect of the present invention, there is provided a file management apparatus comprising: a first display control section which causes a plurality of files serving as management targets to be displayed on a display screen in a list form; a second display control section which causes, each time a file is selected from among the plurality of files by a user as a processing target, a selection order rank set by the user to be individually displayed at a specific position on the display screen corresponding to the file; and a generating section which generates a new file by combining a plurality of files selected by the user as processing targets, in accordance with selection order ranks of the plurality of files set by the user.

In accordance with another aspect of the present invention, there is provided a file management method comprising: displaying, on a display screen, a plurality of files serving as management targets in a list form; individually displaying, each time a file is selected from among the plurality of files by a user as a processing target, a selection order rank set by the user at a specific position on the display screen corresponding to the file; and generating a new file by combining a plurality of files selected by the user as processing targets, in accordance with selection order ranks of the plurality of files set by the user.

In accordance with another aspect of the present invention, there is provided a non-transitory computer-readable storage medium having stored thereon a program that is executable by a computer to actualize functions comprising: displaying, on a display screen, a plurality of files serving as management targets in a list form; individually displaying, each time a file is selected from among the plurality of files by a user as a processing target, a selection order rank set by the user at a specific position on the display screen corresponding to the file; and generating a new file by combining a plurality of files selected by the user as processing targets, in accordance with selection order ranks of the plurality of files set by the user.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention can be more deeply understood by the detailed description below being considered together with the following drawings.

FIG. 1 is a perspective view outlining the structure of a graphic camera system according to one embodiment;

FIG. 2 is a block diagram showing the main portion of the electric structure of the graphic camera system;

FIG. 3 is a flowchart for describing an operation of a tablet;

FIG. 4 is a flowchart following that of FIG. 3;

FIG. 5 is a diagram showing one example of a main screen in a gallery mode;

FIG. 6 is a diagram showing one example of an initial state of an editing operation screen;

FIG. 7 is a diagram showing one example of the editing operation screen in the course of operation; and

FIG. 8 is a diagram showing one example of the updated main screen.

### DETAILED DESCRIPTION OF THE PREFERRED EMBODIMENT

One embodiment will hereinafter be described with reference to the drawings.

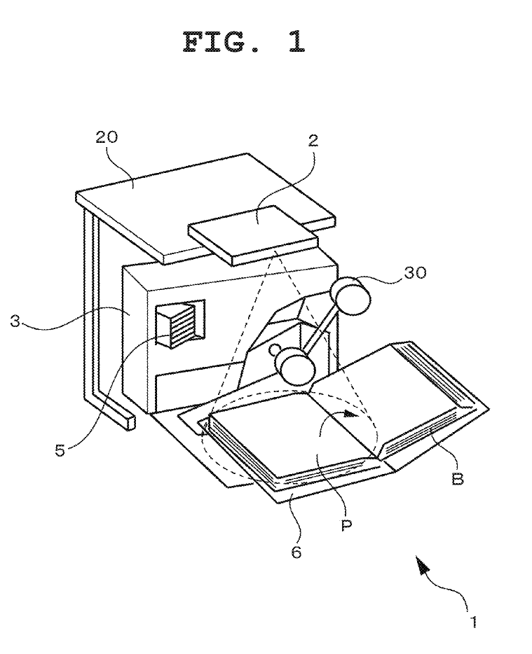

FIG. 1 is a perspective view outlining the structure of a graphic camera system 1 according to one embodiment. This graphic camera system 1 is constituted by a tablet 2 having a function to operate as a file management apparatus and an automatic page turning apparatus 3.

The automatic page turning apparatus 3 includes a holding table 6 which holds an opened book B or the like, a page-turning mechanism 30 which holds a page P at a page-turning start point of the page P of the book B or the like on the holding table 6 and releases the holding of the page P at a page-turning end point of the page P, and an air blowing section 5 which blows air to the page P at the page-turning end point by blowing air such that it passes above the page P at the page-turning start point.

The tablet 2 is a portable information processing terminal including a camera (imaging section described further below). By being installed above the book (or magazine) B by a stand 20, the tablet 2 photographs a page P of the book B at a page-turning start point. The tablet 2 and the automatic page turning apparatus 3 are communicable via a short-range wireless communication adaptor of Bluetooth (registered trademark), Wi-Fi (registered trademark), or the like incorporated therein.

The graphic camera system 1 separates and turns over the pages P of the book B or the like (magazine) by separating the pages P one by one by using the automatic page turning apparatus 3, photographs each page by the tablet 2 for conversion into electronic data, and records electronic data of a plurality of pages as a file in a predetermined format (hereinafter referred to as a book file).

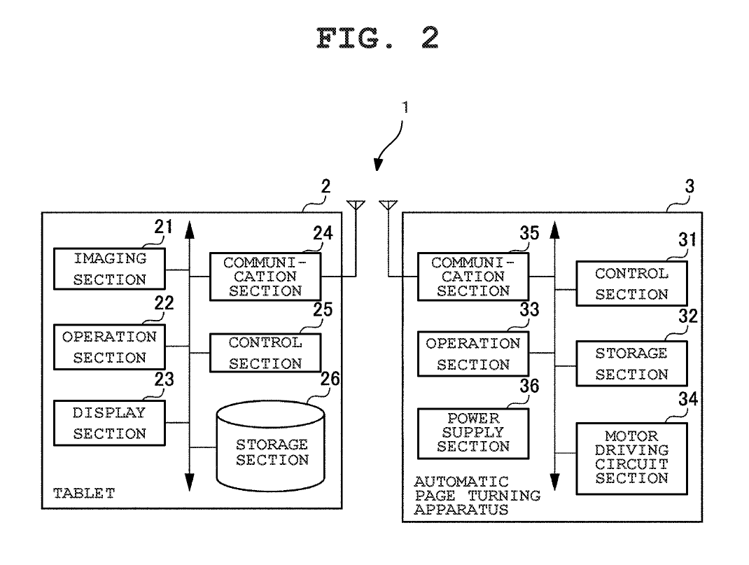

FIG. 2 is a block diagram showing the main portions of the electric structures of the tablet 2 and the automatic page turning apparatus 3. First, the electric structure of the automatic page turning apparatus 3 is described.

The automatic page turning apparatus 3 mainly includes a control section 31, a storage section 32, an operation section 33, a motor drive circuit section 34, a communicating section 35, and a power supply section 36. The storage section 32 includes a ROM (Read Only Memory) having various programs recorded therein and a RAM (Random Access Memory) where these programs are developed.

The operation section 33, for example, includes a start switch for starting page turning processing and a stop switch for stopping page turning processing. The motor drive circuit section 34, for example, includes a motor for driving the page-turning mechanism 30, a motor for driving a fan provided in the air blowing section 5, and a motor driver for driving these motors.

The control section 31 controls the motor drive circuit section 34 from when the start switch is operated until when the stop switch is operated so as to drive the page-turning mechanism 30, and thereby separates and turns the pages P of the book B or the like one by one. The communicating section 35 is a communication interface for communication with the tablet 2, and connects to the tablet 2 by a communication method such as Bluetooth (registered trademark) or Wi-Fi (registered trademark). The power supply section 36 supplies electric power to each of the above-described blocks 31 to 35.

Next, the electric structure of the tablet 2 is described. The tablet 2 mainly includes an imaging section 21, an operation section 22, a display section 23, a communicating section 24, a control section 25, and a storage section 26.

The imaging section 21 is a camera capable of photographing page images of the book B or the like, and has an image sensor constituted by a CCD (Charge Coupled Device) or CMOS (Complementary Metal Oxide Semiconductor), or the like, in addition to an optical system including a lens. By this image sensor, a light image that has entered through the lens is converted into an analog image signal, subjected to color separation and gain adjustment for each color component, and then converted into digital data.

The display section 23 has a display monitor such as an LCD (Liquid Crystal Display) and organic EL (Electro Luminescence), and displays page images captured by the imaging section 21, various types of information, and the like on the screen of the display monitor.

The operation section 22 includes a minimum number of operation switches such as a power supply key not depicted and a touch panel integrally provided on the surface of the display monitor of the display section 23, and supplies information regarding operations on the tablet 2 by the user to the control section 25.

The communicating section 24 is a communication interface for communication with the automatic page turning apparatus 3, and connects the tablet 2 thereto by a communication method such as Bluetooth (registered trademark) or Wi-Fi (registered trademark).

The control section 25 includes a CPU (Central Processing Unit), its peripheral circuits and the like, and a RAM (Random Access Memory), and controls each section of the tablet 2.

In the storage section 26, for example, a semiconductor memory is mounted, and various application programs, various data generated in the process of executing programs by the control section 25, and the like are stored. The above-described application programs include a book management program for photographing each page of a book or the like by the automatic page turning apparatus 3, storing page images acquired by the image photographing in the storage section 26 as book files, and browsing and editing the stored book files.

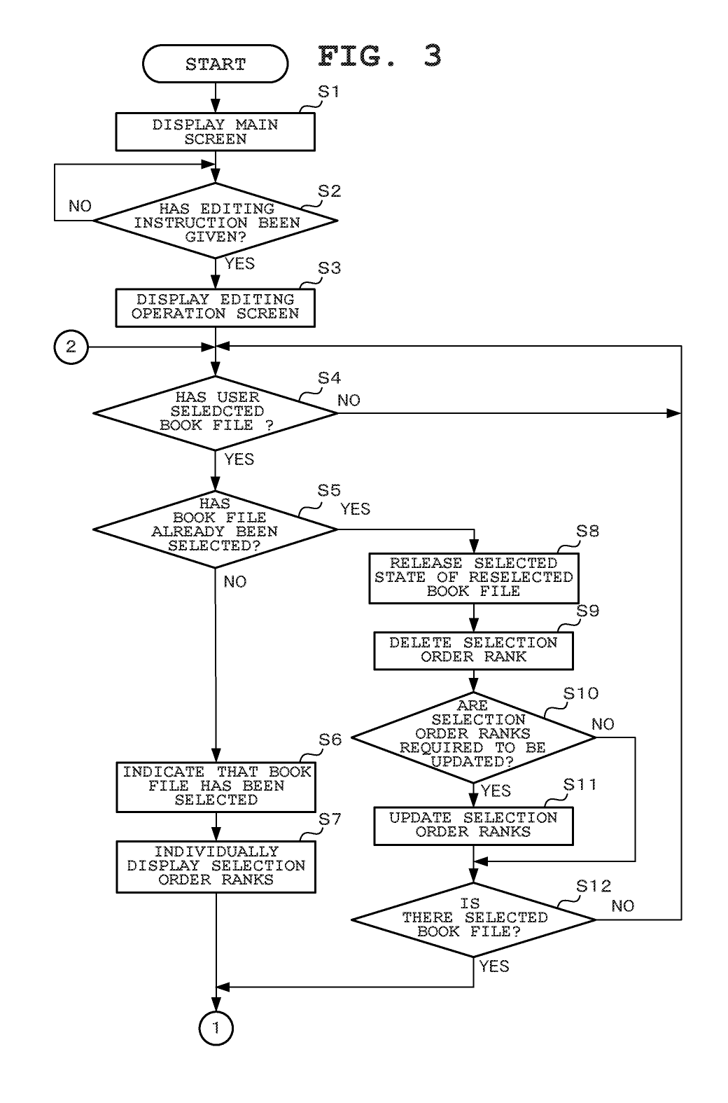

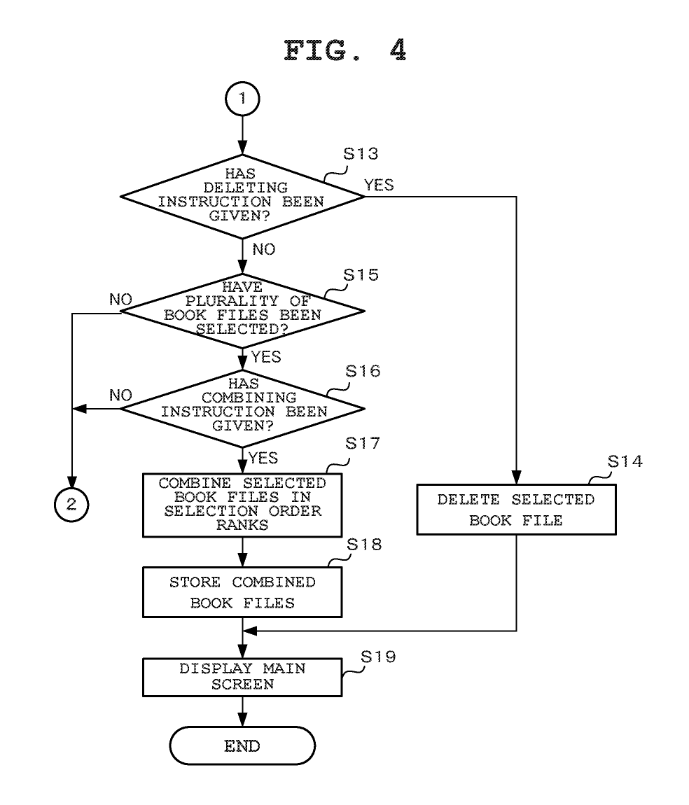

Next, the operation of the tablet 2 is described. FIG. 3 and FIG. 4 show a flowchart for describing processing by the control section 25 when the above-described book management program is started and then a gallery mode is selected by a predetermined operation.

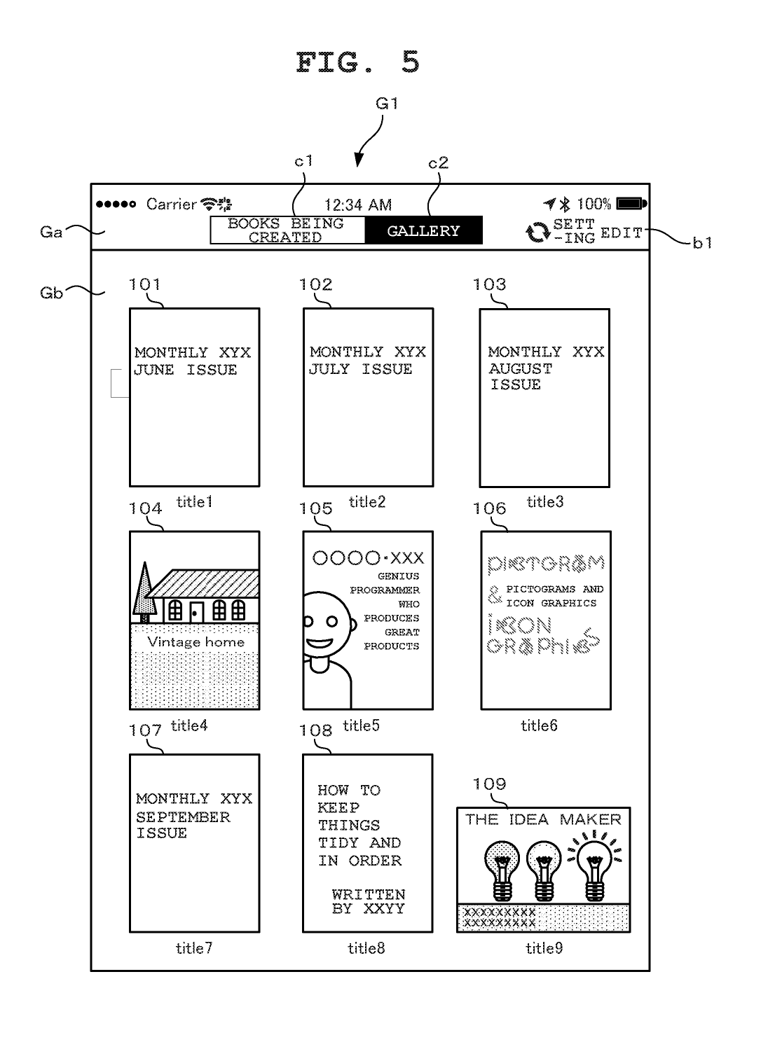

The gallery mode is an operation mode enabling a book file stored in the storage section 26 to be viewed and edited. The control section 25 first causes a main screen G1 depicted in FIG. 5 to be displayed on the display screen of the display section 23 (Step S1).

The main screen G1 is constituted by a function display area Ga allocated by being fixed along an upper edge and a general area Gb other than the function display area Ga. In the function display area Ga, various display elements are displayed, which include state captions c1 and c2 indicating a current operation status by inverse display and an edit button b1 for giving an instruction for editing. Note that display elements displayed on the display screen of the display section 23 to achieve GUI (Graphical User Interface) and constituted by characters, graphics, and the like that are subjected to a touch operation as required by the user are referred to as “buttons”.

For the display of the above-described main screen G1, the control section 25 acquires a page image of a first page from each of a plurality of book files stored in the storage section 26 and, by using a reduced image as a representative image indicating each book file, causes representative images 101, 102, 103, . . . 109 to be displayed in the general area Gb in a list form. That is, the control section 25 causes a plurality of book files stored in the storage section 26 to be displayed in a list form. In the following descriptions, each representative image (reduced image) is referred to as a book file, for convenience of explanation.

Also, for the display of the main screen G1, the control section 25 causes book file names (“title1” to “title9” in FIG. 5) to be displayed on the lower side of the book files 101, 102, 103, . . . 109, respectively.

FIG. 5 is a diagram showing an example where nine book files serving as management targets have been stored in the storage section 26.

Here, although not depicted in FIG. 3, in a case where there are nine or more book files to be managed and all of these book files (representative images) cannot be collectively displayed, the control section 25 allows the remaining book files to be viewed by scrolling the screen (however, only the general area Gb) in response to a scroll operation by the user on the display screen.

Note that, in a case where all book files (representative images) cannot be collectively displayed unlike the present embodiment, a configuration may be adopted in which the plurality of book files (representative images) are displayed by being divided into a plurality of different screens, or in other words, the remaining book files can be checked by switching the display screen in response to a switching operation on the display screen by the user.

Next, when an editing instruction is provided from the user by a touch operation on the edit button b1 (YES at Step S2) while the main screen G1 is being displayed, the control section 25 causes the editing operation screen G2 depicted in FIG. 0.6 to be displayed on the display screen of the display section 23 (Step S3).

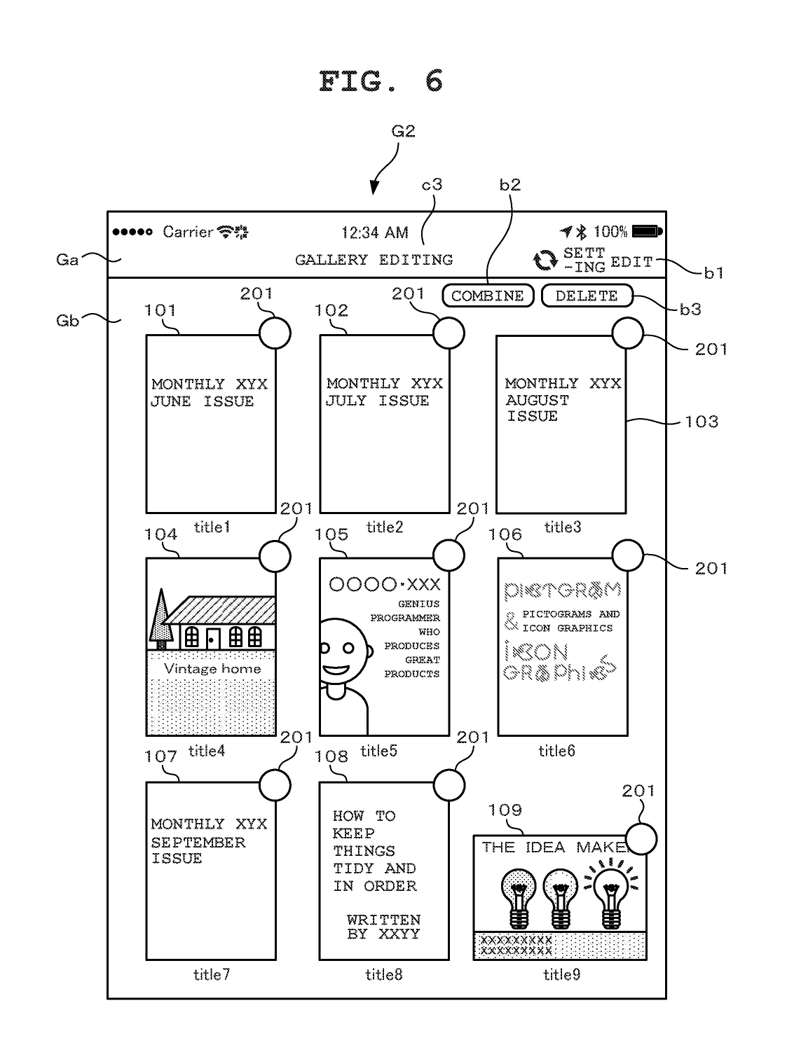

In the editing operation screen G2, the control section 25 causes a caption c3 (“gallery editing” in FIG. 6) indicating a current operation status to be displayed in the function display area Ga, and causes checkboxes 201 individually indicating whether the relevant file has been selected by the user, a combine button b2, and a delete button b3 to be displayed in the general area Gb, in addition to the plurality of book files 101, 102, 103, . . . 109.

After displaying the editing operation screen G2, the control section 25 sequentially judges whether any book file has been selected by the user by a touch operation on the checkbox 201. When a book file is selected (YES at Step S4), the control section 25 performs the following processing.

First, the control section 25 judges whether the book file selected by the user has already been selected (Step S5). When judged that this book file has not yet been selected (NO at Step S5), the control section 25 changes the state of the checkbox 201 of the book file selected by the user to an ON state so that the book file is indicated to have been selected as a processing target (Step S6). Next, the control section 25 causes the selection order ranks of the selected book files (processing targets) set by the user to be individually displayed by using selection order objects described further below (Step S7).

Hereafter, if a deleting instruction is not provided (NO at Step S13 of FIG. 4) and a combining instruction is not provided (NO at Step S16 of FIG. 4) from the user while the editing operation screen G2 is being displayed, the control section 25 repeatedly performs the above-described processing of Steps S6 and S7 each time a new book file is selected by the user, that is, each time a book file that has not been selected is selected by the user.

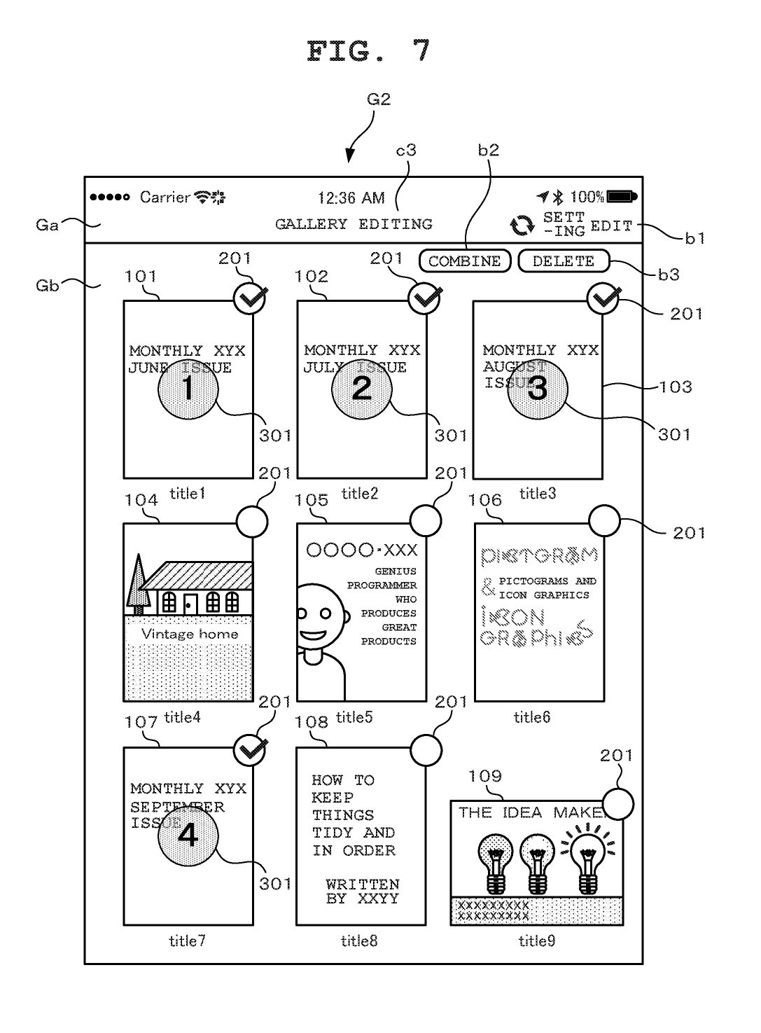

FIG. 7 depicts the state of the editing operation screen G2 after the processing of Steps S6 and S7 is repeated a plurality of times, that is, after a plurality of book files are selected as processing targets, in which four book files 101, 102, 103, and 107 are sequentially selected by the user.

As depicted in FIG. 7, selection order objects 301 indicating the selection order ranks of the book files 101, 102, 103, and 107 each indicate a selection order rank by using, for example, any of circled numbers “1” to “4” with a specific color. In this case, the selection order objects 301 excluding the numbers are displayed at the center of the respective book files 101, 102, 103, and 107 so as to be translucently superimposed thereon (for example, displayed by OSD (On Screen Display)).

At Step S5, when a book file selected by the user has already been selected, that is, if an already-selected book file is reselected (YES at Step S5), the control section 25 performs the following processing.

First, the control section 25 returns the ON state of the checkbox 201 of the book file reselected by the user to an OFF state so as to release the selected state of the book file (Step S8). Next, the control section 25 deletes the selection order rank of the reselected (selected-state-released) book file (Step S9). That is, the control section 25 stops the display of the selection order object 301 displayed by being superimposed on that book file.

In addition, the control section 25 judges whether the selection order ranks (selection order objects 301) of the other book files selected as processing targets are required to be updated (Step S10). Specifically, the control section 25 judges whether the selected-state-released book file is a book file selected last as a processing target.

Here, when the selected-state-released book file is a book file selected last as a processing target and the selection order ranks are not required to be updated (NO at Step S10), the control section 25 judges whether any selected book file is present (Step S12).

Conversely, when the selected-state-released book file is not a book file selected last as a processing target and the selection order ranks are required to be updated (YES at Step S10), the control section 25 updates the selection order ranks of the other book files selected as processing targets (Step S11). That is, the control section 25 pushes up the selection order ranks of book files lower than the selection order rank of the selected-state-released book file by one so as to update the selection order objects 301 displayed by being superimposed on the book files to those indicating new selection order ranks.

Next, the control section 25 judges whether any selected book file is present at this point (Step S12).

Here, when there is no selected book file (NO at Step S12), the control section 25 returns to the processing of Step S4 to continuously repeat the processing of judging whether a book file selecting operation has been performed by the user. Also, if there is one or a plurality of other selected book files when the processing of Steps S8 to S11 is performed by the control section 25 after reselection of the book file (YES at Step S12), in FIG. 4, the control section 25 judges whether a deleting instruction has been provided from the user by touching the delete button b3 (Step S13).

When judged that a deleting instruction has been provided from the user (YES at Step S13), the control section 25 deletes these selected book files present at that point from the storage section 26 (Step S14), and then causes the above-described main screen G1 to be displayed (Step S19). As a result, one editing operation is ended.

At Step S13, when judged that a deleting instruction has not been provided from the user (NO at Step S13), the control section 25 first judges whether a plurality of book files have been selected. If a plurality of book files have not been selected (NO at Step S15), the control section 25 immediately returns to the processing of Step S4 to repeat the following processing. If a plurality of book files have been selected (YES at Step S15), the control section 25 further judges whether a combining instruction has been provided from the user by touching the above-described combine button b2 (Step S16).

When judged that a combining instruction has not been provided from the user (NO at Step S16), the control section 25 immediately returns to the processing of Step S4 to repeat the above-described processing. When judged that a combining instruction has been provided from the user (YES at Step S16), the control section 25 combines all the book files selected as processing targets (Step S17).

That is, the control section 25 combines all the book files selected as processing targets in accordance with the selection order ranks to generate a new book file. Specifically, the control section 25 generates a new book file, that is, a book file of one book constituted by information regarding a series of pages where information regarding the last page of a book file of the first selection order rank is followed by information regarding the head page of a book file of the second selection order rank and information regarding the last page of the book file of the second selection order rank is followed by the head page of a book file of the third selection order rank.

Then, the control section 25 stores the generated new book file in the storage section 26 (Step S18). That is, the control section 25 stores the generated book file as a new management target. In addition, the control section 25 deletes the plurality of book files that are the generation sources (processing targets).

Then, the control section 25 causes the main screen G1 to be displayed on the display screen of the display section 23 (Step S19). That is, the control section 25 causes a new main screen G1 to be displayed, in which a plurality of book files including the book file stored as a new management target in place of the plurality of book files served as the combination targets are displayed in a list form. As a result, one editing operation is ended.

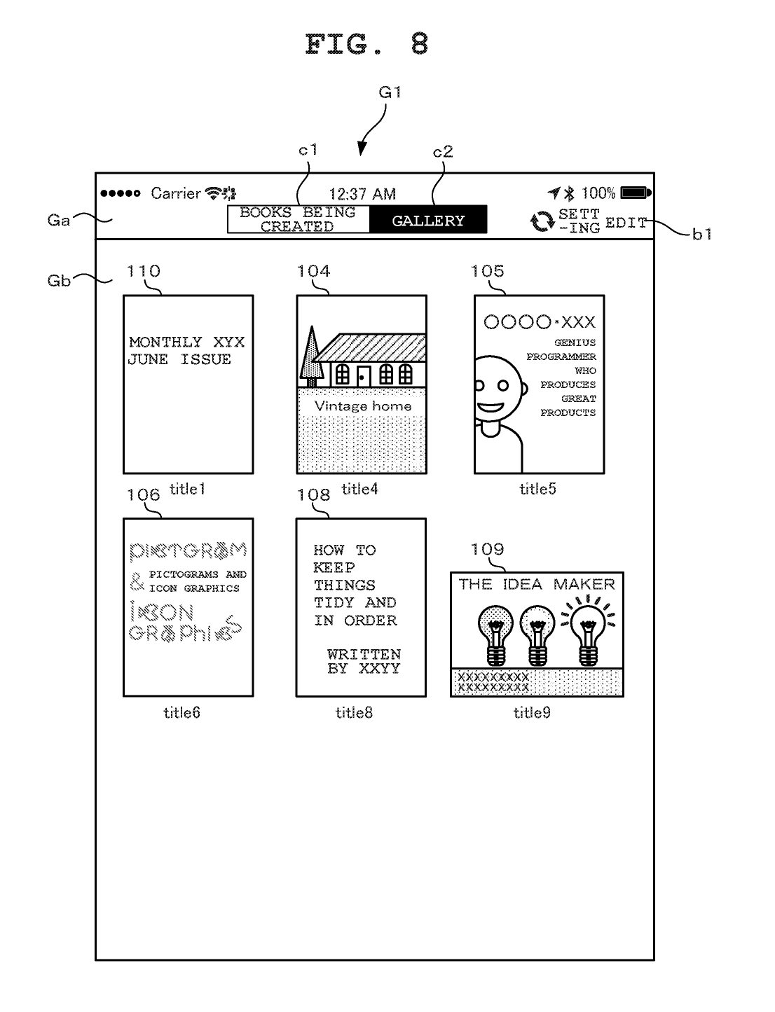

FIG. 8 is a diagram of the new main screen G1 displayed in the processing of Step S19, in which four book files 101, 102, 103, and 107 in FIG. 7 have been combined and a new book file 110 has been generated.

As described above, in the tablet 2, it is possible to not only convert an arbitrary book or the like into electronic data as a book file and store the book file, but also combine a plurality of stored book files to generate a single book file.

Here, the user can select a plurality of book files in the order in which the user desires to combine. Therefore, the combining operation is very easy. Also, at the time of selecting book files, the order of selecting the book files, that is, the combining order can be checked in order. Thus, an error in the combining order can be prevented. As a result, the user can easily manage the stored book files even if the number of stored book files is large. For example, in a case where periodicals such as monthly magazines and weekly magazines and (one or a plurality of) pages of special articles therein have been stored as book files, the plurality of periodicals and special articles can be easily restored as a single book file.

In the present embodiment, when a new book file generated by combining a plurality of book files selected by the user is stored, the original book files are automatically deleted. However, these book files may be left without being deleted.

Also, in the present embodiment, when the user gives an instruction to combine a plurality of selected book files, these book files are immediately combined. However, a configuration may be adopted in which, when a combining instruction is provided from the user, the control section 25 inquires whether book files can be combined on the display screen, and causes a final confirmation screen including a button for giving an instruction to combine the book files or cancelling the combining to be displayed. In this configuration, only when a combining instruction is given, the control section 25 performs combining processing. When a cancelling instruction is given, the control section 25 allows the selection of arbitrary book files again or allows reselection (release of selection) of the selected book files.

In addition, a configuration may be adopted in which a selection release button is provided on the editing operation screen G2 and, when the selection release button is touched, all selected book files present at that point are changed to a non-selected state. That is, all checkboxes 201 may be initialized, and all selection order objects 301 may be deleted.

Also, in the present embodiment, book files that serve as management targets are files where photographic image data acquired by photographing (entire or part of) pages of a book or the like is stored. However, book files that serve as management targets may be files having store therein character data extracted from photographic images acquired by photographing pages of a book or the like by using a known character recognition technique. In addition, the files that serve as management targets are not limited to the book files described herein and may be other files such as document files.

Moreover, in the present embodiment, the present invention has been applied in the tablet 2. However, the present invention is not limited thereto, and can be applied to another information device such as a general personal computer by supplying a program that can achieve the same processing as that described above. In addition, the supply method therefor can be arbitrarily determined. For example, the program may be supplied from a web page on the Internet to a personal computer or the like.

Furthermore, the program may be stored in a server on the Internet, and the processing depicted in FIG. 3 and FIG. 4 may be executed in that server. In this case, the display of the main screen G1 and the editing operation screen G2 and a user operation on these screens are performed in a personal computer or the like in cooperation with the server. Here, newly-generated document files and the like may be stored in the server or may be stored in the personal computer or the like.

While various embodiments have been described, it is intended that the invention be not limited by any of the details of the description therein but includes all the embodiments which fall within the scope of the appended claims.

What is claimed is:

1. A file management apparatus comprising:
a first display control section which causes a plurality of files serving as management targets to be displayed on a display screen in a list form;
a second display control section which causes, each time a file is selected from among the plurality of files by a user as a processing target, a selection order rank set by the user to be individually displayed at a specific position on the display screen corresponding to the file; and
a generating section which generates a new file by combining a plurality of files selected by the user as processing targets, in accordance with selection order ranks of the plurality of files set by the user.

2. The file management apparatus according to claim 1, wherein each of the plurality of files is a file acquired by information regarding a plurality of pages being converted into electronic data for each of the pages.

3. The file management apparatus according to claim 1, further comprising:
a third display control section which causes information regarding processing target selection by the user to be displayed on the display screen for each of the plurality of files displayed on the display screen in the list form while maintaining arrangement of the respective files.

4. The file management apparatus according to claim 1, wherein the second display control section (i) stops, each time an instruction is given from the user so as to release selection of a file among the selected files for which the selection order ranks are being displayed on the display screen, display of a selection order rank of the file for which the instruction to release selection has been given, and (ii) updates selection order ranks displayed corresponding to other selected files.

5. The file management apparatus according to claim 1, wherein the first display control section causes the plurality of files to be displayed on the display screen in the list form by using images indicating file contents.

6. The file management apparatus according to claim 5, wherein the second display control section causes the selection order rank to be displayed by being superimposed on the image.

7. The file management apparatus according to claim 1, wherein the generating section generates, as the new file, a file that serves as a new management target.

8. The file management apparatus according to claim 1, further comprising:
a display section which includes the display screen having a function as a touch panel,
wherein a selecting instruction by the user is given on the display screen.

9. A file management method comprising:
displaying, on a display screen, a plurality of files serving as management targets in a list form;
individually displaying, each time a file is selected from among the plurality of files by a user as a processing target, a selection order rank set by the user at a specific position on the display screen corresponding to the file; and
generating a new file by combining a plurality of files selected by the user as processing targets, in accordance with selection order ranks of the plurality of files set by the user.

10. The file management method according to claim 9, wherein each of the plurality of files is a file acquired by information regarding a plurality of pages being converted into electronic data for each of the pages.

11. The file management method according to claim 9, further comprising:
displaying, on the display screen, information regarding processing target selection by the user for each of the plurality of files displayed on the display screen in the list form while maintaining arrangement of the respective files.

12. The file management method according to claim 9, wherein the displaying of the selection order rank includes (i) stopping, each time an instruction is given from the user so as to release selection of a file among the selected files for which the selection order ranks are being displayed on the display screen, display of a selection order rank of the file for which the instruction to release selection has been given, and (ii) updating selection order ranks displayed corresponding to other selected files.

13. The file management method according to claim 9, wherein the displaying of the plurality of files in the list form includes displaying the plurality of files on the display screen in the list form by using images indicating file contents.

14. The file management method according to claim 13, wherein the displaying of the selection order rank includes displaying the selection order rank by superimposing the selection order rank on the image.

15. A non-transitory computer-readable storage medium having stored thereon a program that is executable by a computer to actualize functions comprising:
displaying, on a display screen, a plurality of files serving as management targets in a list form;
individually displaying, each time a file is selected from among the plurality of files by a user as a processing target, a selection order rank set by the user at a specific position on the display screen corresponding to the file; and
generating a new file by combining a plurality of files selected by the user as processing targets, in accordance with selection order ranks of the plurality of files set by the user.

16. The non-transitory computer-readable storage medium according to claim 15, wherein each of the plurality of files is a file acquired by information regarding a plurality of pages being converted into electronic data for each of the pages.

17. The non-transitory computer-readable storage medium according to claim 15, wherein the program is executable the computer to perform the functions further comprising:
displaying, on the display screen, information regarding processing target selection by the user for each of the plurality of files displayed on the display screen in the list form while maintaining arrangement of the respective files.

18. The non-transitory computer-readable storage medium according to claim 15, wherein the displaying of the selection order rank includes (i) stopping, each time an instruction is given from the user so as to release selection of a file among the selected files for which the selection order ranks are being displayed on the display screen, display of a selection order rank of the file for which the instruction to release selection has been given, and (ii) updating selection order ranks displayed corresponding to other selected files.

19. The non-transitory computer-readable storage medium according to claim 15, wherein the displaying of the plurality of files in the list form includes displaying the plurality of files on the display screen in the list form by using images indicating file contents.

20. The non-transitory computer-readable storage medium according to claim 19, wherein the displaying of the selection order rank includes displaying the selection order rank by superimposing the selection order rank on the image.
